(19) United States
(12) Patent Application Publication
(10) Pub. No.: US 2023/0165180 A1
(43) Pub. Date: Jun. 1, 2023

(54) ADJUSTABLE FURROW CLOSING ASSEMBLY

(71) Applicant: YETTER MANUFACTURING COMPANY, Colchester, IL (US)

(72) Inventors: Derek W. ALLENSWORTH, Macomb, IL (US); Derek A. LITCHFIELD, Macomb, IL (US)

(21) Appl. No.: 18/058,960

(22) Filed: Nov. 28, 2022

Related U.S. Application Data
(60) Provisional application No. 63/283,440, filed on Nov. 27, 2021.

(51) Int. Cl. A01B 63/26; A01C 5/06; A01B 63/00

(52) U.S. Cl. CPC A01B 63/26; A01C 5/068; A01B 63/008

(57) ABSTRACT

An adjustable furrow closing assembly that is used to close a seed furrow formed in the soil during a planting operation. The assembly includes a housing that is pivotally coupled to a planting unit. The housing includes an adjustable carrier that pivots within the housing. The adjustable carrier includes first and second closing wheels that are adapted to engage with the soil to close the seed furrow. The assembly also includes a downforce control lever that extends into the housing and is coupled to the adjustable carrier. The housing includes a gate member that including a plurality of slots. The downforce control lever is configured to be moved from one slot to a next slot of the gate to either increase or decrease downforce that is applied to the closing wheels. The slots formed in the gate to allow the gate position to be adjusted with respect to the housing to calibrate downforce on the closing wheels. The furrow closing assembly also includes an adjustment rod that is coupled to the adjustable carrier such that rotation of adjustment rod in a first direction causes movement of the adjustable carrier in a first direction to increase the angle of the closing wheels and rotation of the adjustment rod in a second direction causes movement of the adjustable carrier in a second direction to decrease the angle of the closing wheels.

### PRIORITY CLAIM

This application claims priority under 35 U.S.C. § 119(e) to U.S. Provisional Application Ser. No. 63/283,440, filed Nov. 27, 2021, which is expressly incorporated herein by reference in its entirety.

### BACKGROUND

The present disclosure relates to furrow closing devices used to close the furrow formed during the planting and particular to furrow closing assemblies. Furrow closing assemblies are coupled to a planting unit and include furrow closing wheels used to close the furrow after the seed is planted into the ground. An agricultural seeding machine such as a row crop planter or grain drill places seeds at a desired depth within a plurality of parallel seed trenches formed in soil. In the case of a row crop planter, a plurality of row crop units are typically ground driven using wheels, shafts, sprockets, transfer cases, chains and the like. Each row crop unit has a frame that is moveably coupled with a tool bar. The frame may carry a main seed hopper, herbicide hopper, insecticide hopper, furrow opener/closer, etc.

### SUMMARY

In accordance with the present disclosure, an adjustable furrow closing assembly is shown.

In illustrative embodiments, the adjustable furrow closing assembly can be coupled to an existing planting unit and is used to close a planting furrow once the seed is deposited. The assembly is used to close a furrow in soil and includes a pair of furrow closing wheels, each having an inner side facing toward each other and positioned adjacent to a corresponding disc outer side. Each wheel also has a leading edge positioned between a corresponding disc leading edge and disc trailing edge, and a trailing edge positioned rearward of a corresponding disc trailing edge relative to the travel direction.

In illustrative embodiments, the adjustable furrow closing assembly includes a housing that is adapted to be coupled to a planter assembly. The housing is configured to allow for the attachment of first and second furrow closing wheels that are designed to close the planting furrow. Downforce applied to furrow closing wheels is controlled by a repositionable downforce control lever. The downforce control lever is designed to operate within a multi-position slide equalizer gate to provide for a plurality of downforce adjustment positions.

In illustrative embodiments, angular adjustment of the furrow closing wheels is controlled by an angle adjustment knob. The housing is configured to house an adjustable carrier that is adapted to allow for the attachment of the furrow closing wheels. Rotation of the angle adjustment knob in a clockwise direction, causes movement of adjustable carrier in a first direction to increase the angle of the closing wheels and rotation of adjustment knob in a counterclockwise direction causes movement of adjustable carrier in a second direction to decrease the angle of the closing wheels.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of an adjustable furrow closing assembly showing a pair of furrow closing wheels coupled to a housing;

FIG. 2 is another perspective view of the adjustable furrow closing assembly with one of the furrow closing wheels removed showing the axle shaft that the furrow closing wheel mounts to and showing the dial indicator that allows a user to know the amount of angle has been applied to the furrow closing wheels;

FIG. 3 is another perspective view of the adjustable furrow closing assembly showing rotation of the angle adjustment knob to adjust the angle of the furrow closing wheels as illustrated by the arrow;

FIG. 4 is another perspective view of the adjustable furrow closing assembly showing the downforce control lever and the angle adjustment knob used to control downforce and angle of the furrow closing wheels;

FIG. 5 is a side elevational view of the adjustable furrow closing assembly showing one of the furrow closing wheels removed and also showing that rotation of the angle adjustment know causes angular movement of the furrow closing wheels;

FIG. 6 is a perspective view of the downforce control lever and an adjustable control lever gate that can be adjusted by a user to fine tune the amount of downforce that is being applied to the furrow closing wheels;

FIG. 7 is a side elevation of the adjustable furrow closing assembly with one of the wheels removed and portions of the housing cut away to show movement of the downforce control lever being moved from a first to a second position;

FIG. 8 is a perspective view of a portion of the housing showing a pair of attachment arms and the spherical bearings used to couple the housing to a planter unit;

FIG. 9 is a cutaway view of one of the spherical bearings of FIG. 8; and

FIG. 10 is an exploded view of the adjustable furrow closing assembly.

### DETAILED DESCRIPTION

In illustrative embodiments, an adjustable furrow closing assembly 10 is adapted to be coupled to a planter (not shown) to close the furrow created by a furrow opening disc. Adjustable furrow closing assembly 10 is configured to provide flexibility to quickly change wheel angle settings for planting speed, seed depth, tillage practices and soil conditions. Adjustable furrow closing assembly 10 also allows for downforce to be calibrated so that downforce is uniform in adjacent Adjustable furrow closing assembly units.

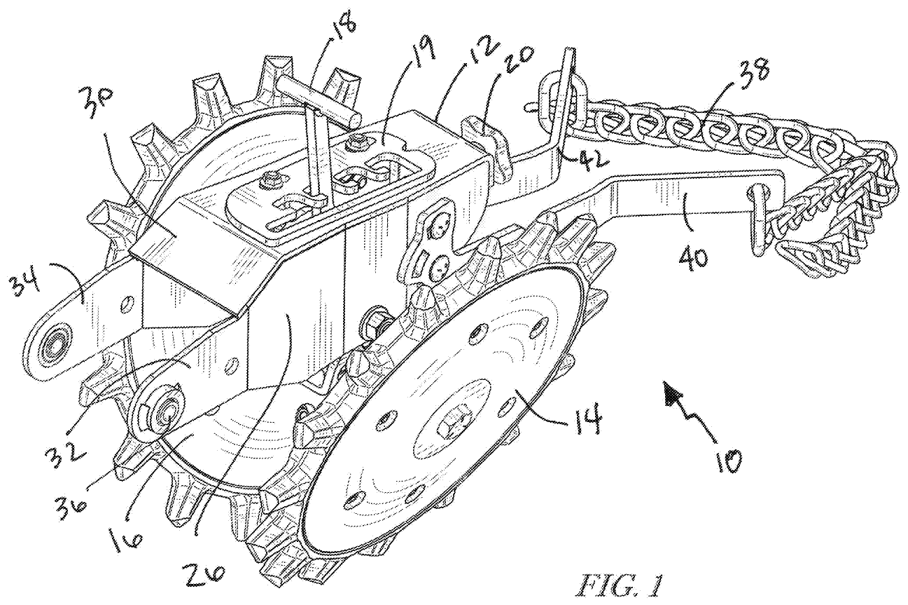

As illustrated in FIGS. 1 and 10, adjustable furrow closing assembly 10 includes a housing 12 that is adapted to be coupled to a planter assembly. Housing 12 is configured to allow for the attachment of first and second furrow closing wheels 14, 16. Downforce applied to furrow closing wheels 14, 16 by spring 24 is controlled by downforce control lever 18. Downforce control lever 18 is designed to operate within a multi-position slide equalizer gate 19 that is configured to provide for a plurality of downforce adjustment positions to control how much force closing wheels 14, 16 apply to the ground. Angular adjustment of furrow closing wheels 14, 16 is controlled by angle adjustment knob 20. Housing 12 is configured to house adjustable carrier 22. Adjustable carrier 22 is adapted to allow for the attachment of the furrow closing wheels 14, 16. Downforce is applied to carrier 22 and wheels 14, 16 by downforce spring 24.

Housing 12 includes a first side wall 26, a spaced apart second side wall 28, and a top wall 30. Top wall 30 is formed to include an opening 31 to allow for movement of downforce control handle 18. Side walls 26, 28 extend forward to form a pair of attachment arms 32, 34. Attachment arms 32, 34 include bearings 36, which allow housing 12 to be pivotally coupled to a planter unit. Housing 12 may also include a drag chain 38 that is adapted to be coupled to the housing 12 by a pair of drag arms 40, 42. Drag chain 38 is used as a final step in closing the seed furrow after the furrow closing wheels 14, 16 have displaced soil over the furrow.

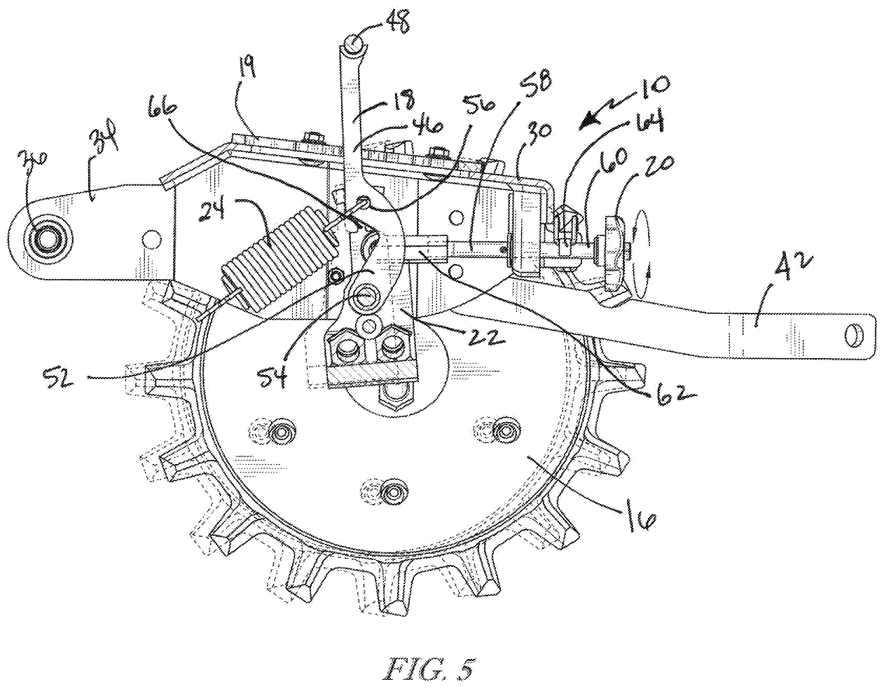

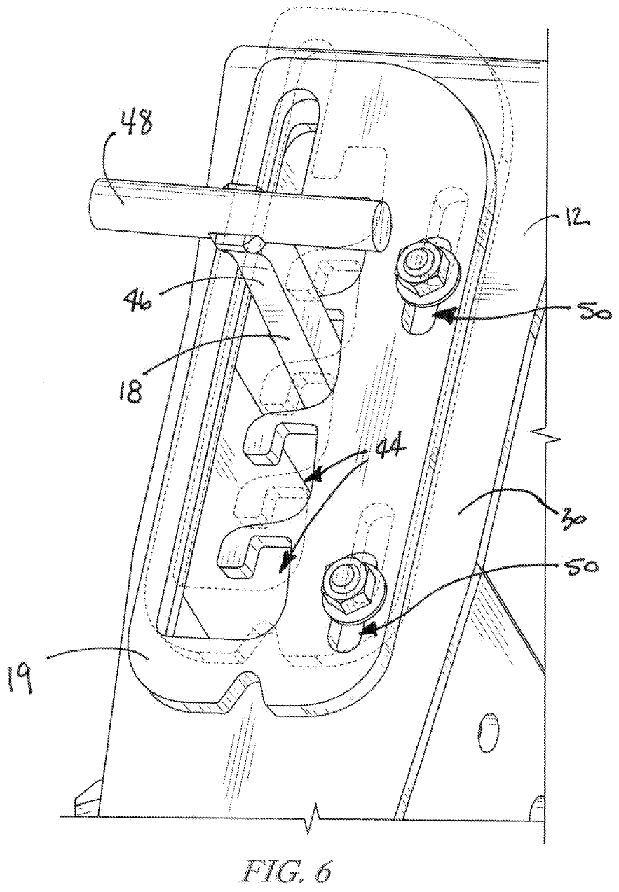

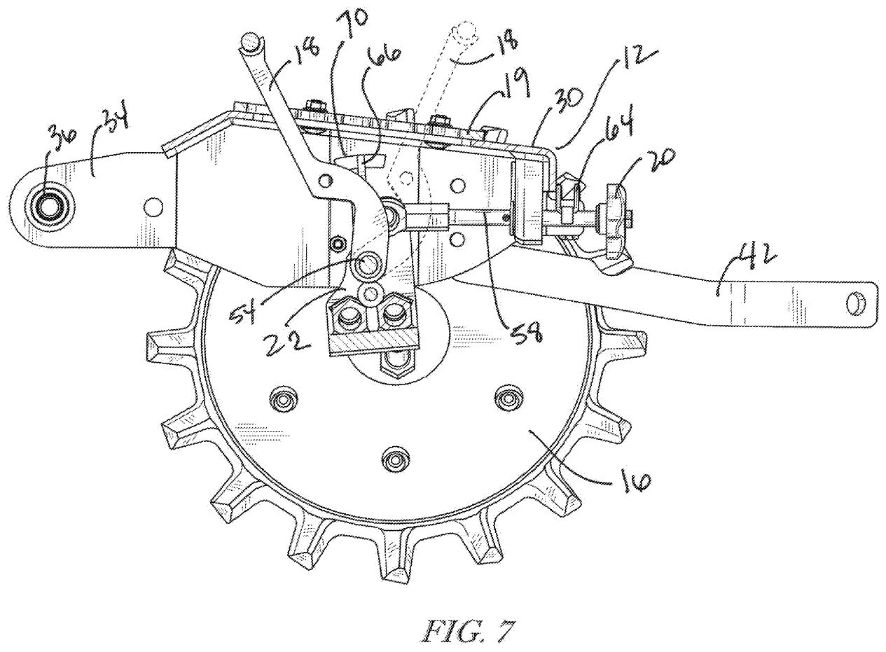

Downforce control lever 18 is used to allow for adjustment of spring downforce on the closing wheels 14, 16, by moving lever 18 to various slots 44 formed in gate 19, as shown in FIGS. 5 and 6. Slide equalizer gate 19 is adapted to be coupled to top wall 30 of housing 12. Lever 18 includes a shaft 46 and a handle 48 coupled to the shaft to form a T-shaped configuration. Gate 19 is formed to include a series of hooked or “L” shaped slots 44 that provide for a plurality of downforce adjustment positions. Lever 18 can be positioned in any one of the slots 44 to increase or decrease downforce. Gate 19 includes slide equalizer slots 50.

Equalizer slots 50 allow gate 19 to be adjusted with respect to housing 12 to calibrate row-to-row downforce settings on each adjustable furrow closing assembly 10. A planting assembly being pulled behind a motive source, such as a tractor, can have as many as twenty or more planting units. Each planting unit includes a furrow closing assembly. Closing wheel downforce can vary from one furrow closing assembly to the next. Equalizer slots 50 allow a user to adjust the downforce for each furrow closing assembly so that uniform downforce is applied to the field across the planting assembly. Downforce can be measured with a scale by a user and gate 19 can be adjusted by loosening bolts securing gate 10 to housing 12 at equalizer slots 50 so that each unit is properly calibrated with respect to all closing assemblies.

Downforce control lever 18 includes shaft 46 that extends downward into housing 12, as shown in FIG. 5. Shaft includes a lower end 52 that is formed to include a pivot 54 that is pivotally coupled to adjustable carrier 22. Shaft 46 is also formed to include an aperture 56 that is adapted to accept one end of downforce spring 24. Movement of shaft 46 from one slot 44 to the next of gate 19 either increases or decreases downforce that is applied to closing wheels 14, 16 depending upon the direction lever 18 is moved.

Adjustable furrow closing assembly 10 also includes the ability to quickly and easily adjust the camber or angle of the closing wheels 14, 16. Camber adjustment is caused by movement of several components within housing 12. Camber adjustment system preferably includes a 20 degree range of camber adjustment of closing wheels 14, 16 with −5 degree negative camber adjustment to +15 positive camber adjustment. Camber adjustment settings bring the seed trench closed, eliminating air pockets and enhancing seed to soil contact. Camber adjustment system includes adjustable carrier 22, which is pivotally coupled to housing 12 about pivot 54. Closing wheels 14, 16 are rotatably coupled to adjustable carrier 22. The lower portion of adjustable carrier 22 is angled in a generally v-shaped configuration so that when closing wheels 14, 16 are bolted to adjustable carrier 22 they are in a v-shaped configuration when in contact with the ground. Stated another way, the bottom edges of the closing wheels 14, 16 are closer than the upper edges.

Adjustment system also includes angle adjustment knob 20, which is coupled to adjustment rod 58. Adjustment rod 58 is coupled to the knob 20 at a first end 60 and is pivotally coupled to adjustable carrier 22 at a second end 62 by a link member. Adjustment rod 58 is threaded with link member so that rotation of adjustment knob 20 in a clockwise direction, causes movement of adjustable carrier in a first direction to increase the camber of closing wheels 14, 16 and rotation of adjustment knob 20 in a counterclockwise direction causes movement of adjustable carrier 22 in a second direction to decrease camber. Rotation of adjustment knob 20 causes adjustable carrier 22 and closing wheels 14, 16 together to rotate about pivot 54 to cause the camber of the wheels 14, 16 to either increase or decrease. Lock pin 64 is used to lock adjustment rod 58 in distinct lock positions to prevent unwanted rotation of knob 20 during use. Lock pin 64 is adapted to be positioned within an aperture of adjustment rod 58 to prevent rotation during use of adjustable furrow closing assembly 10.

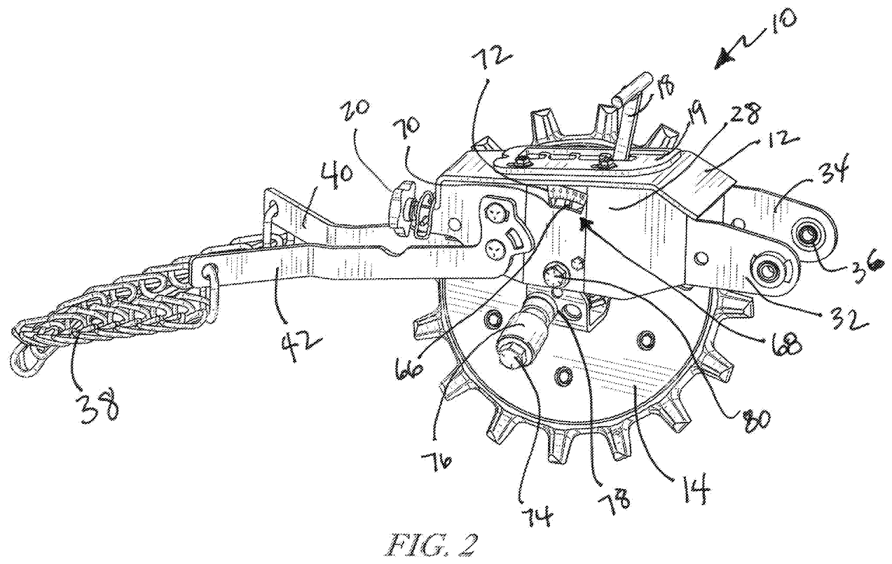

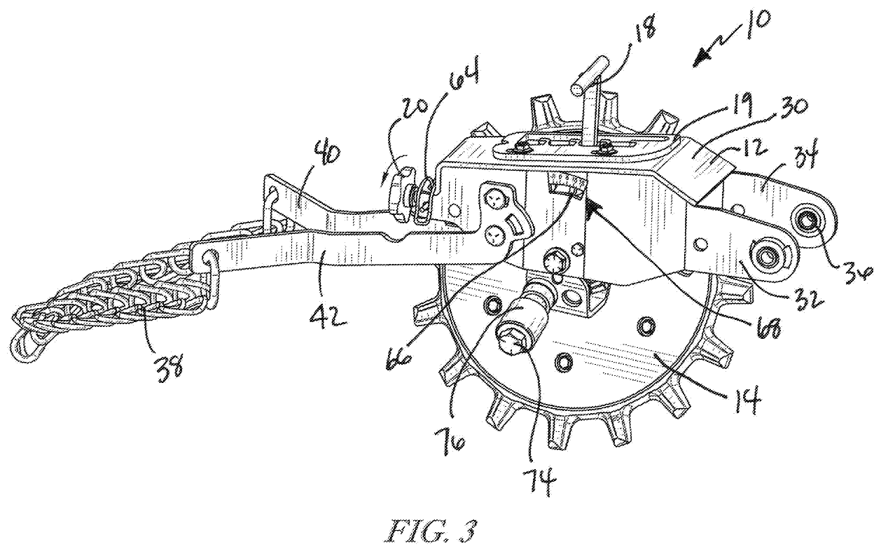

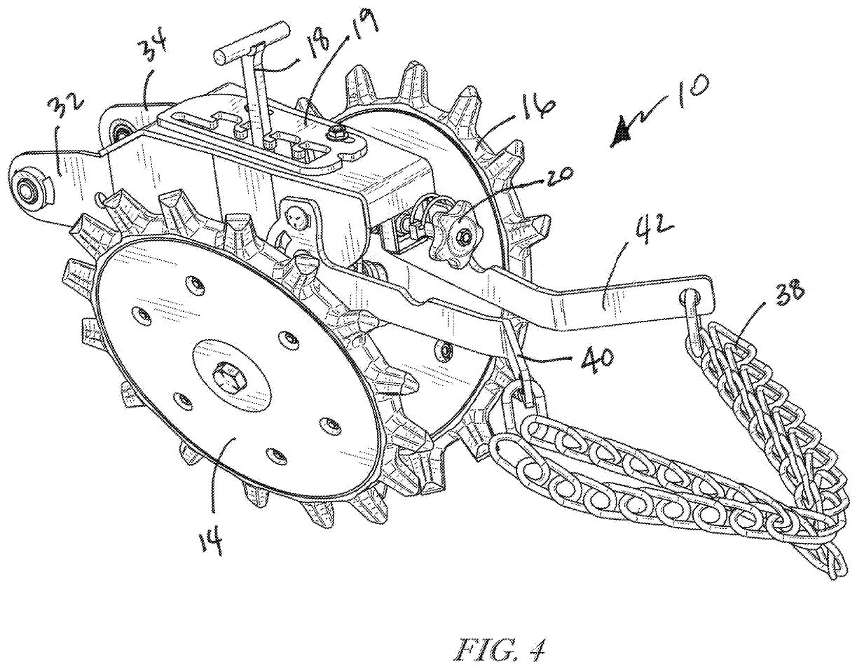

Adjustment system also includes a dial indicator 68 that allows a user to visually see the current camber position of the first and second wheels 14, 16, as shown in FIG. 2. Indicator 68 is formed to include a window 70 and indicia 72 that includes positive and negative camber markings. Window 70 is adapted to allow needle 66 from adjustable carrier 22 to be visible through the window 70. Needle 66 moves within window 70 as adjustment knob 20 is rotate and points at the current camber position of the adjustable carrier 22 and closing wheels 14, 16 at that given time.

Closing wheels 14, 16 are coupled to adjustable carrier 22 by use of a pair of axle shafts 74. Axle shafts 74 are used to secure first and second closing wheels 14, 16 to the adjustable carrier 22. Axles shafts 74 are secured to adjustable carrier 22 by screwing the axle shafts 74 into apertures 78 formed in the lower end of the adjustable carrier 22. This allows for quick removal of closing wheels 14, 16 as there is no need to hold a separate hex nut with a wrench. Axle shafts 74 may include a bushing or bearing 76 that aids the wheels 14, 16 in rotating when engaged with the ground. Fastener 80 is used to secure adjustable carrier 22 to housing and allows carrier 22 to rotate with respect to the housing 12. Bolt 80 also secures downforce control lever 18 to housing 12 and creates pivot point 54 that allows the adjustable carrier 22 to rotate with respect to housing 12. Both control lever 18 and adjustable carrier 22 rotate about the same axis of rotation with respect to the housing 12. This arrangement simplifies assembly, and reduces construction and maintenance costs.

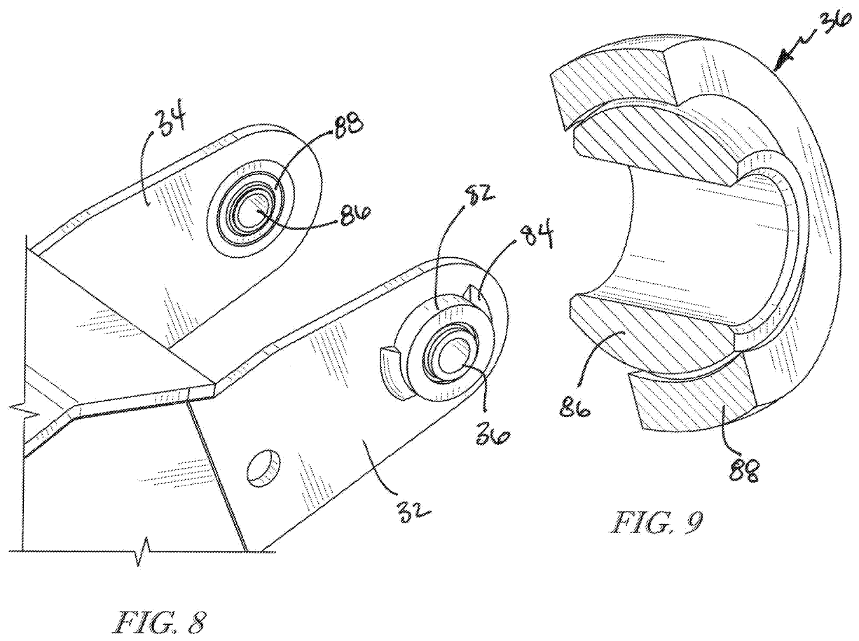

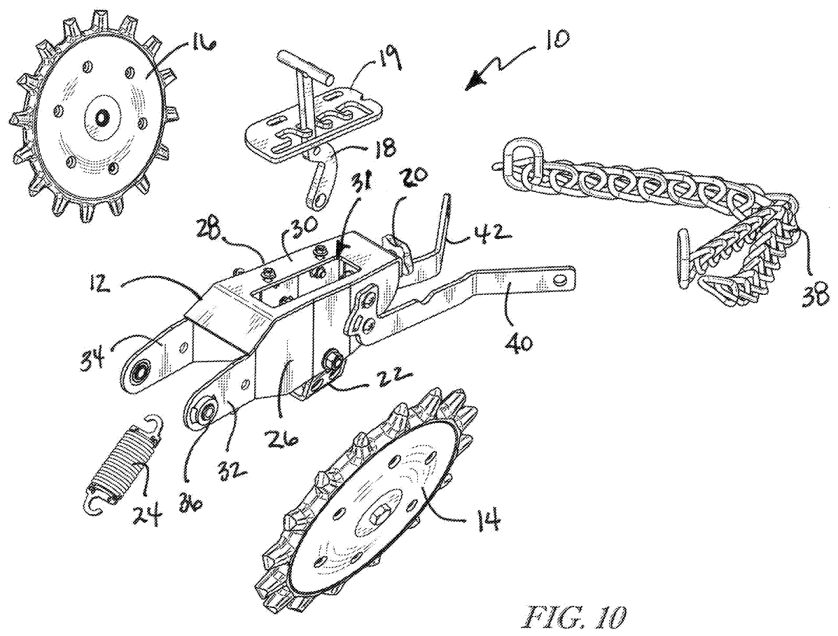

Attachment arms 32, 34 are used to secure adjustable furrow closing assembly 10 to a planter unit. Arms 32, 34 each include a bearing 36 that allows adjustable furrow closing assembly 10 to pivot with respect to the planter unit, as shown in FIGS. 8 and 9. Bearings 36 are retained by use of flanges 82 that are secured to arms 32, 34 by welds 84. Bearings 36 are preferably replaceable self-aligning pivot bearings having a an inner spherical member 86 and an exterior housing 88. Preferably, bearings are GEZ spherical ball-swivel bearings that are configured to improve wear life and eliminate or greatly reduce unwanted side-to-side movement of the adjustable furrow closing assembly 10.

Various features of the invention have been particularly shown and described in connection with the illustrative embodiment of the invention, however, it must be understood that these particular arrangements may merely illustrate, and that the invention is to be given its fullest interpretation within the terms of the appended claims.

What is claimed is:

1. An adjustable furrow closing assembly for closing a seed furrow in soil comprising:
a housing that is configured to be coupled to a planting unit, the housing including a carrier;
first and second closing wheels configured to be coupled to the carrier, the closing wheels adapted to engage with the soil to close the seed furrow;
a downforce control lever that extends into the housing and is coupled to the carrier;
a gate member coupled to the housing and including a plurality of slots, the control lever configured to be moved from one slot to a next slot of the gate to either increase or decrease downforce that is applied to the closing wheels; and
slots formed in the gate to allow the gate position to be adjusted with respect to the housing to permit calibration of downforce on the closing wheels.

2. The adjustable furrow closing assembly of claim 1, wherein the downforce control lever includes a handle.

3. The adjustable furrow closing assembly of claim 2 wherein the downforce control lever is pivotally coupled to adjustable carrier.

4. The adjustable furrow closing assembly of claim 3, wherein the slots in the gate member are generally L-shaped.

5. The adjustable furrow closing assembly of claim 1, wherein the downforce control lever is configured to include a downforce spring that applies a downforce on the closing wheels.

6. The adjustable furrow closing assembly of claim 1, wherein the carrier is adjustable.

7. The adjustable furrow closing assembly of claim 6, wherein the closing wheels are coupled to the lower portion such that the closing wheels are angled with respect to each other.

8. The adjustable furrow closing assembly of claim 7, further including an adjustment rod that is coupled to the adjustable carrier wherein rotation of adjustment rod in a first direction causes movement of the adjustable carrier in a first direction to increase the angle of the closing wheels and rotation of the adjustment rod in a second direction causes movement of the adjustable carrier in a second direction to decrease the angle of the closing wheels.

9. The adjustable furrow closing assembly of claim 8, further including a dial indicator that indicates camber position of the first and second wheels, the dial indicator includes indicia in the form of positive and negative camber markings and further includes a needle that moves with the adjustable carrier and is used to indicate the amount of camber to a user.

10. The adjustable furrow closing assembly of claim 7, further including axles shafts that secure the closing wheels to the adjustable carrier wherein the axle shafts are threaded into apertures formed in the lower portion of the adjustable carrier.

11. An adjustable furrow closing assembly for closing a seed furrow in soil comprising:
a housing that is configured to be coupled to a planting unit, the housing including an adjustable carrier;
first and second closing wheels adapted to be coupled to the adjustable carrier, the closing wheels adapted to engage with the soil to close the seed furrow, the closing wheels are oriented at an angle with respect to each other; and
an adjustment rod that is coupled to the adjustable carrier such that rotation of adjustment rod in a first direction causes movement of the adjustable carrier in a first direction to increase the angle of the closing wheels and rotation of the adjustment rod in a second direction causes movement of the adjustable carrier in a second direction to decrease the angle of the closing wheels.

12. The adjustable furrow closing assembly of claim 11, wherein the adjustable carrier includes a lower portion and the closing wheels coupled to the lower portion such that the closing wheels are angled with respect to each other.

13. The adjustable furrow closing assembly of claim 12, further including axles shafts that are used to secure the closing wheels to the adjustable carrier wherein the axle shafts are threaded into apertures formed in the lower portion of the adjustable carrier.

14. The adjustable furrow closing assembly of claim 11, further including a dial indicator that indicates camber position of the first and second wheels, the dial indicator includes indicia having positive and negative camber markings and further includes a needle that moves with the adjustable carrier to indicate the amount of camber to a user.

15. The adjustable furrow closing assembly of claim 11, further including a lock pin that is configured to lock the adjustment rod in distinct lock positions and to prevent unwanted rotation of adjustment rod.

16. An adjustable furrow closing assembly for closing a seed furrow in soil comprising:
a housing that is configured to be coupled to a planting unit, the housing including an adjustable carrier;
first and second closing wheels configured to be coupled to the adjustable carrier, the closing wheels adapted to engage with the soil to close the seed furrow;
a downforce control lever that extends into the housing and is coupled to the adjustable carrier;
a gate member coupled to the housing and including a plurality of slots, the downforce control lever configured to be moved from one slot to a next slot of the gate to either increase or decrease downforce that is applied to the closing wheels;
slots formed in the gate to allow the gate position to be adjusted with respect to the housing to calibrate downforce on the closing wheels; and
an adjustment rod that is coupled to the adjustable carrier such that rotation of adjustment rod in a first direction causes movement of the adjustable carrier in a first direction to increase the angle of the closing wheels and rotation of the adjustment rod in a second direction causes movement of the adjustable carrier in a second direction to decrease the angle of the closing wheels.

17. The adjustable furrow closing assembly of claim 16, further including axles shafts that are used to secure the closing wheels to the adjustable carrier wherein the axle shafts are threaded into apertures formed in the lower portion of the adjustable carrier.

18. The adjustable furrow closing assembly of claim 16, further including a dial indicator that indicates camber position of the first and second wheels, the dial indicator includes indicia having positive and negative camber markings and further includes a needle that moves with the adjustable carrier to indicate the amount of camber to a user.

19. An adjustable furrow closing assembly for closing a seed furrow in soil comprising:
a housing that is configured to be coupled to a planting unit, the housing including a carrier;
first and second closing wheels configured to be coupled to the carrier, the closing wheels adapted to engage with the soil to close the seed furrow;
a downforce control lever that extends into the housing and is coupled to the carrier;
a gate member coupled to the housing and including a plurality of slots, the downforce control lever configured to be move from one slot to a next slot of the gate to either increase or decrease downforce that is applied to the closing wheels;
slots formed in the gate to allow the gate position to be adjusted with respect to the housing to calibrate row-to-row downforce pressure on the closing wheels to match downforce between adjacent adjustable furrow closing assemblies;
an adjustment rod that is coupled to the adjustable carrier such that rotation of adjustment rod in a first direction causes movement of the adjustable carrier in a first direction to increase the angle of the closing wheels and rotation of the adjustment rod in a second direction causes movement of the adjustable carrier in a second direction to decrease the angle of the closing wheels; and
a lock pin that is configured to lock adjustment rod in distinct lock positions and to prevent unwanted rotation of adjustment rod.
